(19) United States
(12) Patent Application Publication
(10) Pub. No.: US 2020/0234008 A1
(43) Pub. Date: Jul. 23, 2020

(54) INFORMATION PROCESSING METHOD AND DEVICE

(71) Applicant: BEIJING KINGSOFT INTERNET SECURITY SOFTWARE CO., LTD., Beijing (CN)

(72) Inventor: Yumeng Song, Beijing (CN)

(73) Assignee: BEIJING KINGSOFT INTERNET SECURITY SOFTWARE CO., LTD., Beijing (CN)

(21) Appl. No.: 16/792,368

(22) Filed: Feb. 17, 2020

Related U.S. Application Data
(63) Continuation of application No. PCT/CN2018/106729, filed on Sep. 20, 2018.

(30) Foreign Application Priority Data
May 8, 2018 (CN) 201810432516.1

(51) Int. Cl. G06F 40/295; G06F 40/30; G06F 3/0481

(52) U.S. Cl. CPC G06F 40/295; G06F 3/04817; G06F 40/30

(57) ABSTRACT

Disclosed is an information processing method, an information processing device, a terminal device and a storage medium. The method includes: determining whether input information on a current application interface includes a named entity; if it is detected that the input information includes the named entity, acquiring and displaying entity content corresponding to the named entity on the current application interface; and acquiring a transmitting instruction and transmitting the entity content to a target user.

### CROSS-REFERENCE TO RELATED APPLICATIONS

This application is a continuation application of PCT Patent Application No. PCT/CN2018/106729, filed on Sep. 20, 2018, which claims priority to and benefits of Chinese Patent Application Serial No. 201810432516.1, filed on May 8, 2018. The entire contents of these applications are incorporated herein by reference.

### FIELD

The present disclosure relates to a field of information processing technology, and in particular, to an information processing method, apparatus, and device.

### BACKGROUND

When a user is chatting with an Input Method, the user may encounter a such scenario that, when an entity is mentioned by the user, the user may desire to transmit content related to entity to the receiver. For example, the entity may be a named entity, and the transmitter desires to transmit the content related to the named entity to the receiver.

In the related art, in order to acquire information related to the named entity in a chat scene, it needs to quit a current application interface, activate a browser to search the named entity, copy or capture a screenshot of content after the content related to the named entity is acquired, and transmit the content to the receiver. Operations in the related art are complicated, and input efficiency is low.

### SUMMARY

The present disclosure provides the information processing method, including:

detecting whether input information on a current application interface includes a named entity;

in response to detecting that the input information includes the named entity, acquiring and displaying entity content corresponding to the named entity on the current application interface; and

acquiring a transmitting instruction, and transmitting the entity content to a target user.

The present disclosure provides a terminal device, including a processor and a memory. The processor is configured to execute a program corresponding to an executable program code by reading the executable program code stored in the memory to execute the information processing method described above.

The present disclosure provides a non-transitory computer readable storage medium, having a computer program stored thereon. When the computer program is executed by the processor, an information processing method described above is executed.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

FIG. 1 is a flow chart illustrating an information processing method according to embodiments of the present disclosure;

FIG. 2 is a schematic diagram illustrating entity content according to embodiments of the present disclosure;

FIG. 3 is a flow chart illustrating another information processing method according to embodiments of the present disclosure;

FIGS. 4-7 are schematic diagrams illustrating entity icons according to embodiments of the present disclosure;

FIG. 8 is a flow chart illustrating another information processing method according to embodiments of the present disclosure;

FIG. 9 is a schematic diagram illustrating a picture identifier according to embodiments of the present disclosure;

FIG. 10 is a block diagram illustrating an information processing apparatus according to embodiments of the present disclosure;

FIG. 11 is a block diagram illustrating another information processing apparatus according to embodiments of the present disclosure;

FIG. 12 is a block diagram illustrating another information processing apparatus according to embodiments of the present disclosure;

FIG. 13 is a block diagram illustrating another information processing apparatus according to embodiments of the present disclosure;

FIG. 14 is a block diagram illustrating an exemplary terminal device suitable for implementing embodiments of the present disclosure.

### DETAILED DESCRIPTION

Embodiments of the present disclosure will be described in detail and examples of embodiments are illustrated in the drawings. The same or similar elements and the elements having the same or similar functions are denoted by like reference numerals throughout the descriptions. Embodiments described here with reference to drawings are explanatory, serve to explain the present disclosure, and are not construed to limit embodiments of the present disclosure.

The present disclosure provides an information processing method, an information processing device, a mobile terminal and a storage medium. With the present disclosure, it is detected whether the input information on the current application interface includes the named entity. In response to detecting that the input information includes the named entity, the entity content corresponding to the named entity is acquired and displayed on the current application interface. The transmitting instruction is further acquired, and the entity content is transmitted to the target user. Therefore, the content entity of the named entity is displayed on the current application interface and transmitted to the target user without switching the application, thereby reducing the frequency of switching the application by the user during the chatting process and improving the input efficiency.

An information processing method, apparatus, and device according to embodiments of the present disclosure are described below with reference to the accompanying drawings.

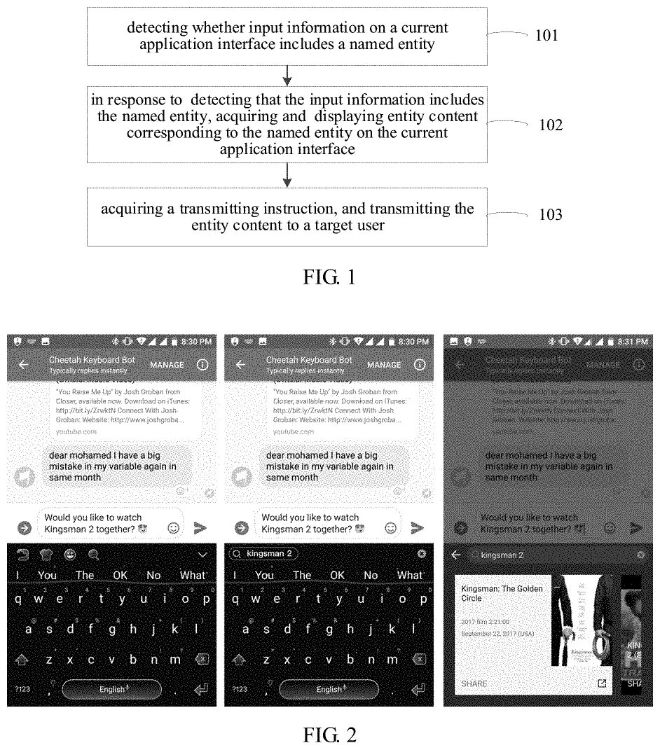

FIG. 1 is a flow chart illustrating an information processing method according to embodiments of the present disclosure. As illustrated in FIG. 1, the information processing method may include the following.

At block 101, it is detected whether input information on a current application interface includes a named entity.

The information processing method according to embodiments of the present disclosure may be applied to a terminal device, such as smart phone, tablet computer, personal digital assistant and wearable device. When a user is chatting with another through an application program (such as QQ, WeChat and the like) on a terminal device, it may be detected whether the named entity is included in the input information on the current application interface.

As a possible implementation, the input information on the current application interface may be identified and analyzed according to a semantic analysis algorithm, to identify whether the input information on the current application interface includes the named entity.

As another possible implementation, named entities may be stored locally or in a cloud server. The input information may be directly matched with the stored named entities according to an NER (Named Entity Recognition) algorithm, to identify the named entity included in the input information on the current application interface. The named entity may be a person name, an organization name, a place name, or any other entities identified by their names. For example, the named entity may also be a song name, a movie name, date, currency, an address, or the like.

It should be noted that, the semantic analysis algorithm and the NER algorithm may be provided by a local terminal device, or may be provided by the cloud server. The server may be requested once every time when a single character is input during an input process to detect whether the currently input information includes the named entity. In another example, the server may be requested once every time when a length of the input information reaches a preset value during the input process to detect whether the currently input information includes the named entity. The present disclosure is not limited to the above.

At block 102, in response to detecting that the input information includes the named entity, entity content corresponding to the named entity is acquired and displayed on the current application interface.

In an embodiment of the present disclosure, a database may be set in advance locally or at a cloud server and the named entities and the entity content corresponding thereto may be stored in the database. In a case where it is detected that the input information includes the named entity, the detected named entity is matched with the named entities stored in the database to obtain and display the entity content corresponding to the named entity which matching the detected named entity on the current application interface.

For example, as illustrated in FIG. 2, it is detected that the input information on the current application interface “Would you like to watch Kingsman 2 together?” includes the named entity “Kingsman 2 (movie name: Kingsman 2)”. The detected named entity “Kingsman 2” is matched with the named entities stored in the database. After the matching is successful, a named entity key may be generated on a keyboard interface of an Input Method. The entity content corresponding to the “Kingsman 2” may be acquired and displayed by clicking the named entity key on the current application interface.

In an embodiment of the present disclosure, after it is detected that the input information includes the named entity, a search engine may be invoked through a background invoking interface of the terminal device. The named entity may be directly searched through the search engine, to acquire and display the entity content corresponding to the named entity on the current application interface.

It should be noted that, the entity content may be displayed on the keyboard interface of the Input Method, displayed on other areas according to actual requirements, or displayed in a floating layer manner, which is not limited herein. The entity content may be directly displayed after being acquired, or acquired and displayed by triggering the named entity key after the named entity key is generated on the application interface, which is not limited herein.

At block 103, a transmitting instruction is acquired, and the entity content is transmitted to a target user.

Implementations of the transmitting instruction may include, but not limited to, a click instruction and a voice instruction, which is not limited here.

In embodiments, since the entity content is already displayed on the current application interface, the entity content may be transmitted to the target user by acquiring the transmitting instruction. Therefore, the entity content is acquired and transmitted to the target user without switching applications during the chat process, thereby improving input efficiency. In addition, it does not need to copy or capture a screenshot of the entity content for the user to send the entity content, thereby simplifying user operations.

In an embodiment of the present disclosure, after the entity content is displayed on the current application interface, it may be detected whether the transmitting instruction is acquired within a preset time period. In a case where the transmitting instruction is not acquired, the entity content may be not displayed. Therefore, by prohibiting displaying the entity content in a case where the transmitting instruction is not acquired within the preset time period, it may avoid that the entity content occupies spaces of the display interface for a long time, thereby improving user experience.

It may be understood that, during the chat process, the user may desire to transmit the content, introduction, and other related information of a certain thing to the other party. For example, when talking about a movie, the user may wish to transmit the information related to the movie to the other party. In this case, it needs to quit the chatting interface, search the movie through the search engine, and copy or capture a screenshot of the searched content, and transmit the copied content or the screenshot to the other party, which is complicated and cause poor user experience. Therefore, with the information processing method according to embodiments of the present disclosure, it is detected whether the input information on the current application interface includes the named entity. In a case where the input information includes the named entity, the entity content corresponding to the named entity is acquired and displayed on the current application interface. The transmitting instruction is further acquired, and the entity content is transmitted to the target user. Therefore, the content of the named entity is displayed on the current application interface and is transmitted to the target user without switching the application, thereby reducing frequency of switching the application by the user during the chatting process and improving input efficiency.

Based on the above embodiment, further, when it is detected that the input information includes the named entity, an entity type corresponding to the named entity may also be acquired and displayed on the current application interface.

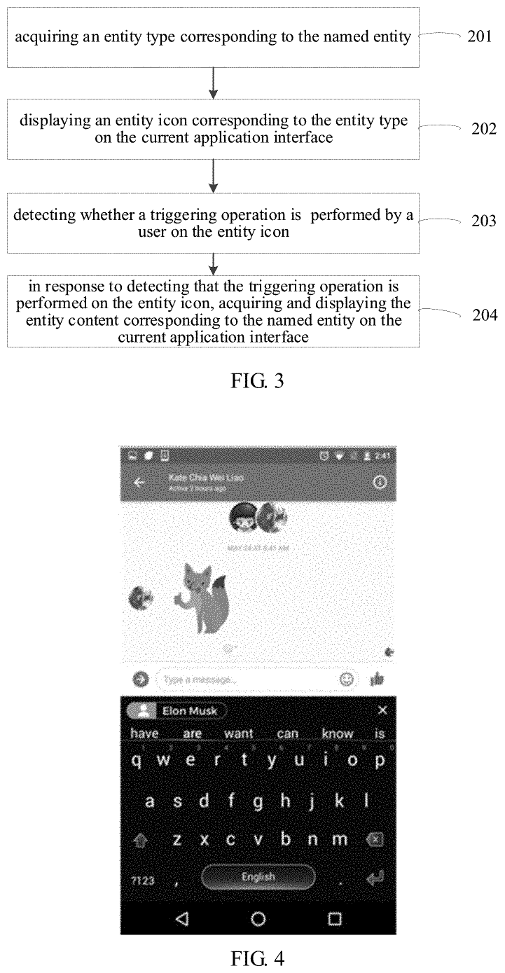

FIG. 3 is a flow chart illustrating another information processing method according to embodiments of the present disclosure. As illustrated in FIG. 3, after it is detected that input information includes the named entity, the information processing method may further include the following.

At block 201, the entity type corresponding to the named entity is acquired.

In an embodiment of the present disclosure, the database may be set in advance locally at the terminal device or at the cloud server. The named entities and the corresponding entity types may be stored in the database. In a case where it is detected that the input information includes the named entity, the detected named entity is matched with the named entities stored in the database and the entity type corresponding to the named entity matching the detected named entity is further acquired.

The entity types may include, but are not limited to, a person name, a place name, a song name, a movie name, and the like.

At block 202, an entity icon corresponding to the entity type is displayed on the current application interface.

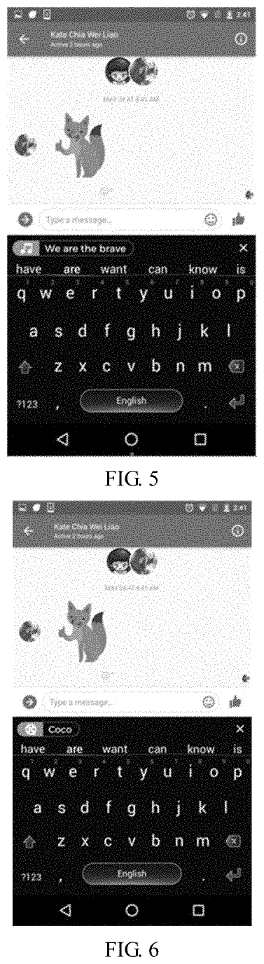

In an embodiment of the present disclosure, a mapping relation table may be preset locally at the terminal device or at the cloud server. The relation between the entity type and the entity icon may be stored in the mapping relation table. After the entity type is acquired, the entity icon corresponding to the entity type is acquired by inquiring the mapping relation table. The entity icon may be displayed on the current application interface. For example, as illustrated in FIG. 4, the named entity is “Elon Musk”, and the entity type acquired corresponding to the named entity is the person name. The entity icon representing the person name is acquired and displayed on the keyboard interface of the Input Method. As another example, as illustrated in FIG. 5, the named entity is “We are the brave”, and the entity type acquired corresponding to the named entity is the song name. The entity icon representing the song name is acquired and displayed on the keyboard interface of the Input Method. As another example, as illustrated in FIG. 6, the named entity is “Coco” and the entity type acquired corresponding to the named entity is the movie name. The entity icon representing the movie name is acquired and displayed on the keyboard interface of the Input Method. As another example, as illustrated in FIG. 7, the named entity is “West Hollywood” and the entity type acquired corresponding to the named entity is the place name. The entity icon representing the place name is acquired and displayed on the keyboard interface of the Input Method.

It should be noted that, the entity icon may be displayed on the keyboard interface of the Input Method, displayed on another area according to the actual requirements, or displayed in the floating layer manner, which is not limited here.

Therefore, in response to detecting that the input information includes the named entity, the entity type corresponding to the named entity is acquired and provided to the user as the entity icon, such that the user may identify the entity type directly, thereby improving input experience of the user.

Further, a same named entity may have different meanings. For example, the named entity “Harry Potter” may be the movie name, the book name, or the person name. When the user is talking about a movie-related topic, the user may prefer to acquire the entity content of the movie “Harry Potter”. Therefore, in a case where multiple entity types are acquired based on the same named entity, the entity icon corresponding to each entity type may be acquired respectively. The entity icons may be displayed on the current application interface respectively, such that the name entities with the same name may be distinguished more intuitively, and the user may select the named entities conveniently. The multiple entity icons may be displayed side by side in a row, side by side in a column, or in any arrangement according to the actual requirements, which is not limited here.

At block 203, it is detected whether the user performs a triggering operation on the entity icon.

At block 204, in response to detecting that the triggering operation is performed on the entity icon, the entity content corresponding to the named entity is acquired and displayed on the current application interface.

In an embodiment of the present disclosure, the user may perform the triggering operation on the entity icon to acquire the entity content. After the entity icon is displayed on the current application interface, it is detected whether the user performs the triggering operation on the entity icon with a related algorithm. After it is detected that the triggering operation is performed on the entity icon, the entity content corresponding to the named entity is acquired and displayed on the current application interface. Because the entity icon occupies less space, the interface may be more attractive, thereby improving the input experience of the user.

The triggering operation of the user performed on the entity icon may be a click, a double-click, a sliding, and the like, which is not limited here. It should be noted that, explanations of embodiments for acquiring and displaying the entity content corresponding to the named entity on the current application interface are also applicable to embodiments illustrated in FIG. 3, which is elaborated here.

With the information processing method according to embodiments of the present disclosure, the entity type corresponding to the named entity is acquired. The entity icon corresponding to the entity type is displayed on the current application interface. It is detected whether the user performs the triggering operation on the entity icon. In a case where it is detected that the triggering operation is performed on the entity icon, the entity content corresponding to the named entity is acquired and displayed on the current application interface. Therefore, in a case where the input information includes the named entity, the entity type corresponding to the named entity is acquired and the entity type is provided to the user as the entity icon, such that the user may conveniently identify the entity type directly, thereby improving the input experience of the user.

Based on the above, further, an emotion entity included in the input information may be detected. In a case where the emotion entity is detected, an emotion picture corresponding to the emotion entity is displayed on the current application interface.

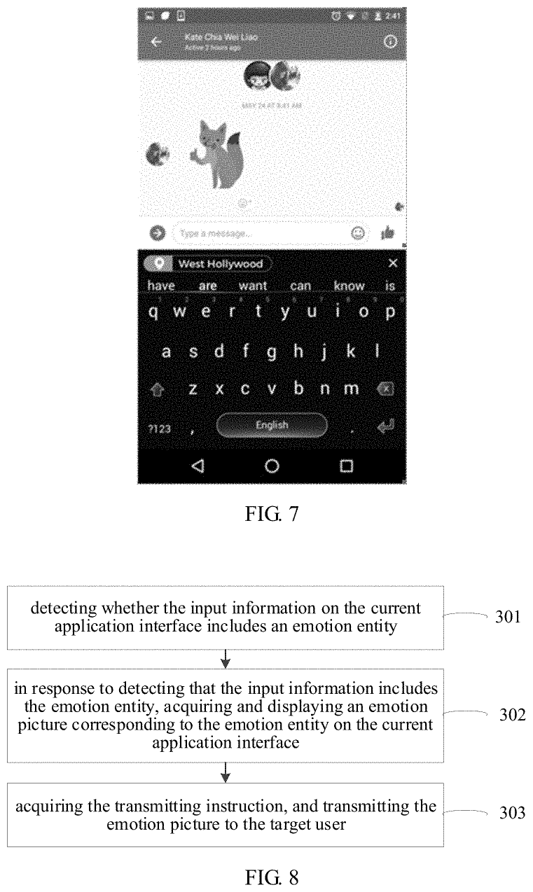

FIG. 8 is a flow chart illustrating another information processing method according to embodiments of the present disclosure. As illustrated in FIG. 8, the information processing method may include the following.

At block 301, it is detected whether the input information on the current application interface includes an emotion entity.

As a possible implementation, the input information on the current application interface may be identified and analyzed based on a semantic analysis algorithm, to identify whether the input information on the current application interface includes the emotion entity.

As another possible implementation, emotion entities may be stored locally at the terminal device or at the cloud server. The input information may be directly matched with the stored emotion entities based on the NER algorithm, to identify the emotion entity included in the input information on the current application interface.

The emotion entity may be a greeting (e.g. good night), or a word representing mood (e.g. smiling, gloomy), etc.

At block 302, in response to detecting that the input information includes the emotion entity, an emotion picture corresponding to the emotion entity is acquired and displayed on the current application interface.

It should be noted that, explanations of above embodiments for acquiring and displaying the entity content corresponding to the named entity on the current application interface is also applicable to embodiments illustrated in FIG. 8 for acquiring and displaying the emotion picture corresponding to the emotion entity on the current application interface, which is not elaborated here.

The emotion picture may be a still picture or a dynamic picture.

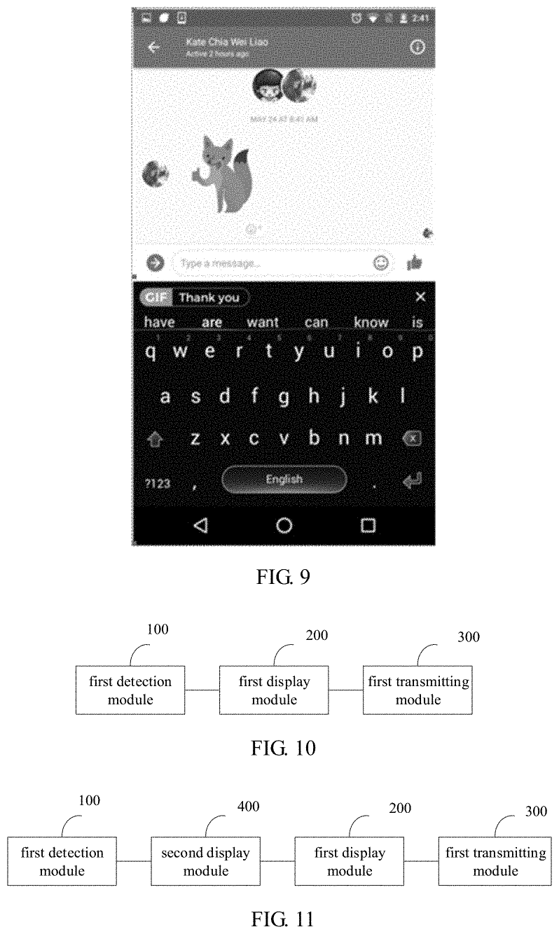

In an embodiment of the present disclosure, in a case where it is detected that the input information includes the emotion entity, a picture identifier may be displayed on the current application interface. For example, as illustrated in FIG. 9, it is detected that the input information includes the emotion entity “Thank you”. The picture identifier “GIF” is displayed on the current application interface, such that the user may directly identify the emotion entity, thereby improving the input experience of the user.

Furthermore, it may be further detected whether the user performs the triggering operation on the picture identifier. In response to detecting that the triggering operation is performed on the picture identifier, the emotion picture corresponding to the emotion entity is acquired and displayed on the current application interface, so that the interface is more attractive, and the input experience of the user is improved.

The triggering operation of the user performed on the picture identifier may be a click, a double-click, a sliding, and the like, which is not limited here.

At block 303, the transmitting instruction is acquired, and the emotion picture is transmitted to the target user.

The implementation of transmitting instruction may include, but not limited to, a click instruction, a voice instruction, and the like, which is not limited here.

In embodiments, since the emotion picture is already displayed on the current application interface, the emotion picture may be transmitted to the target user by acquiring the transmitting instruction. Therefore, the emotion picture may be acquired and transmitted to the target user without switching the application during the chat process, thereby improving the input efficiency. In addition, the user may directly transmit the emotion picture without copying or capturing the screenshot of the emotion picture, thereby simplifying the user operation.

In an embodiment of the present disclosure, after the emotion picture corresponding to the emotion entity is displayed on the current application interface, it may be detected whether the transmitting instruction is acquired within the preset time period. In a case that the transmitting instruction is received within the preset time period, the emotion picture is forbidden to be displayed. Therefore, in a case that the transmitting instruction is not acquired within the preset time period, the display of the emotion picture is cancelled, such that the emotion picture does not occupy spaces of the display interface for a long time, thereby further improving the user experience.

With the information processing method according to embodiments of the present disclosure, by detecting whether the input information on the current application interface includes the emotion entity, the emotion picture corresponding to the emotion entity is acquired and displayed on the current application interface in response to detecting that the input information includes the emotion entity. The transmitting instruction is further acquired, and the emotion picture is transmitted to the target user. Therefore, the emotion entity included in the input information is detected, the emotion picture is displayed on the current application interface and transmitted to the target user without switching the application, thereby reducing the frequency of switching the application by the user during the chatting process and improving the input efficiency.

In order to implement above embodiments, the present disclosure further proposes an information processing apparatus. FIG. 10 is a block diagram illustrating an information processing apparatus according to embodiments of the present disclosure. As illustrated in FIG. 10, the information processing apparatus may include: a first detection module 100, a first display module 200 and a first transmitting module 300.

The first detection module 100 may be configured to detect whether input information on the current application interface includes a named entity.

The first display module 200 may be configured to, in response to detecting that the input information includes the named entity, acquire and displaying entity content corresponding to the named entity on the current application interface.

The first transmitting module 300 may be configured to acquire the transmitting instruction, and transmit the entity content to the target user.

Further, the first display module 200 may be configured to detect whether the transmitting instruction is acquired within a preset time period; and in response to detecting the transmitting instruction is not acquired, cancel displaying of the entity content.

On the basis of FIG. 10, the information processing apparatus provided in FIG. 11 may further include a second display module 400.

The second display module 400 may be configured to acquire an entity type corresponding to the named entity; and display an entity icon corresponding to the entity type on the current application interface.

The first display module 200 may be configured to detect whether the user performs a triggering operation on the entity icon; and in response to detecting that the triggering operation is performed on the entity icon, acquire and display the entity content corresponding to the named entity on the current application interface.

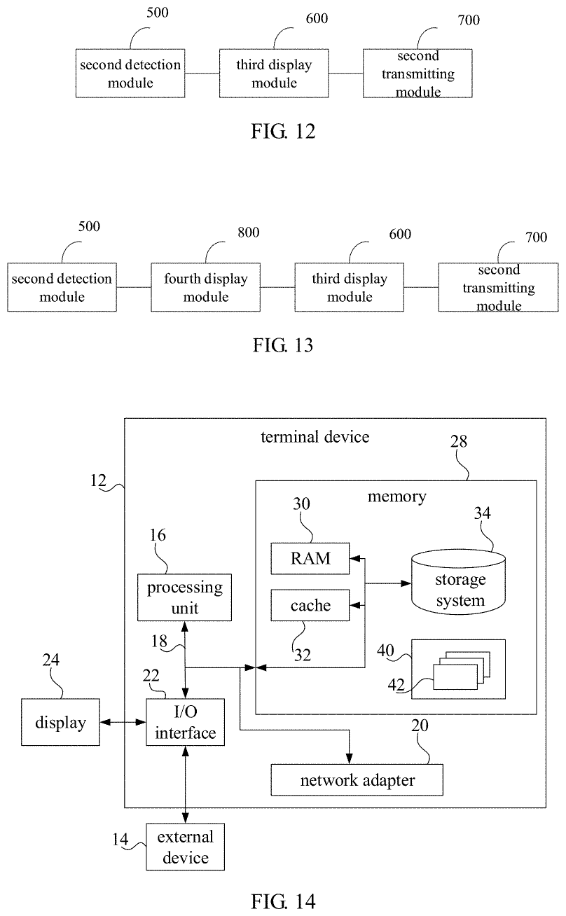

FIG. 12 is a block diagram illustrating another information processing apparatus according to embodiments of the present disclosure. As illustrated in FIG. 12, the information processing apparatus may include a second detection module 500, a third display module 600, and a second transmitting module 700.

The second detection module 500 may be configured to detect whether the input information on the current application interface includes an emotion entity.

The third display module 600 may be configured to, in response to detecting that the input information includes the emotion entity, acquire and display an emotion picture corresponding to the emotion entity on the current application interface.

The second transmitting module 700 may be configured to acquire the transmitting instruction, and transmit the emotion picture to the target user.

Further, the third display module 600 may be configured to detect whether the transmitting instruction is acquired within a preset time period; and in response to detecting the transmitting instruction is not acquired, cancel displaying of the emotion picture.

On the basis of FIG. 12, the information processing apparatus provided in FIG. 13 may further include a fourth display module 800.

The fourth display module 800 may be configured to display a picture identifier on the current application interface.

The third display module 600 may be further configured to detect whether the user performs the triggering operation on the picture identifier; and in response to detecting that the triggering operation is performed on the picture identifier, acquire and display the emotion picture corresponding to the emotion entity on the current application interface.

It should be noted that, explanations of the information processing method according to above embodiments are also applicable to the information processing apparatus according to this embodiment, which is not repeated here.

With the information processing apparatus according to embodiments of the present disclosure, it is detected whether the input information on the current application interface includes the named entity. The entity content corresponding to the named entity is acquired and displayed on the current application interface in response to detecting that the input information includes the named entity. The transmitting instruction is acquired and the entity content is transmitted to the target user. Therefore, the entity content of the named entity may be displayed on the current application interface and transmitted to the target user without switching the application, thereby reducing the frequency of switching the application by the user during the chatting process, and improving the input efficiency.

In order to implement above embodiments, the present disclosure further provides a terminal device. The terminal device may include a processor and a memory. The processor is configured to execute a program corresponding to executable program codes by reading the executable program codes stored in the memory, to implement the information processing method according to any one of the foregoing embodiments.

In order to implement the foregoing embodiments, the present disclosure further provides a computer program product. When instructions of the computer program product are executed by a processor, an information processing method according to any one of the foregoing embodiments is executed.

In order to implement the above embodiments, the present disclosure also provides a non-transitory computer-readable storage medium, having computer programs stored thereon. When the computer programs are executed by a processor, the processor is configured to implement an information processing method according to any one of the foregoing embodiments.

FIG. 14 is a block diagram illustrating an exemplary terminal device for implementing embodiments of the present disclosure. The terminal device 12 illustrated as FIG. 14 is only an example, and should not be considered as a restriction on the function and the usage range of embodiments of the present disclosure.

As illustrated in FIG. 14, the terminal device 12 may be in the form of a general-purpose computing device. Components of the terminal device 12 may include, but are not limited to: one or more processors or processing units 16, a system memory 28, and a bus 18 for connecting different system components (including the system memory 28 and the processing units 16).

The bus 18 represents one or more of several types of bus architectures, including a memory bus or a memory control bus, a peripheral bus, a graphic acceleration port (GAP) bus, a processor bus, or a local bus using any bus architecture in a variety of bus architectures. For example, these architectures include, but are not limited to, an industry standard architecture (ISA) bus, a micro-channel architecture (MCA) bus, an enhanced ISA bus, a video electronics standards association (VESA) local bus, and a peripheral component interconnect (PCI) bus.

Typically, the terminal device 12 may include multiple kinds of computer-readable media. These media may be any storage media accessible by the terminal device 12, including transitory or non-transitory storage medium and movable or unmovable storage medium.

The memory 28 may include a computer-readable medium in a form of volatile memory, such as a random-access memory (RAM) 30 and/or a high-speed cache memory 32. The terminal device 12 may further include other transitory/non-transitory and movable/unmovable computer system storage media. In way of example only, the storage system 34 may be used to read and write from and to non-removable and non-volatile magnetic media (not illustrated in the FIG. 14, commonly referred to as “hard disk drives”). Although not illustrated in FIG. 14, a disk driver for reading and writing to and from movable and non-volatile magnetic disks (e.g. “floppy disks”) may be provided, as well as an optical driver for reading and writing to and from movable and non-volatile optical disks (e.g. a compact disc read only memory (CD-ROM), a digital video disc read only Memory (DVD-ROM), or other optical media) may be provided. In these cases, each driver may be connected to the bus 18 via one or more data interfaces. The system memory 28 may include at least one program product. The program product may have a set of (for example at least one) program modules. The program modules may be configured to perform functions of embodiments of the present disclosure.

A program/application 40 having a set of (at least one) program modules 42 may be stored in system memory 28. The program modules 42 may include, but not limit to, an operating system, one or more application programs, other program modules and program data. Any one or a combination of above examples may include an implementation in a network environment. The program modules 42 may be generally configured to implement functions and/or methods described in embodiments of the present disclosure.

The terminal device 12 may also communicate with one or more external devices 14 (e.g., a keyboard, a pointing device, a display 24, and etc.) and may also communicate with one or more devices that enables a user to interact with the terminal device 12, and/or any device (e.g., a network card, a modem, etc.) that enables the terminal device 12 to communicate with one or more other computing devices. The above communications can be achieved by the input/output (I/O) interface 22. Furthermore, the terminal device 12 may also communicate with one or more networks (e.g., a Local Area Network (LAN), a Wide Area Network (WAN) and/or a public Network such as the Internet) via the Network adapter 20. As shown, the network adapter 20 may communicate with other modules of the terminal device 12 over the bus 18. It should be understood that although not illustrated in the figures, other hardware and/or software modules may be used in combination with the terminal device 12, including, but not limited to, microcode, device drivers, redundant processing units, external disk drive arrays, RAID systems, tape drives, as well as data backup storage systems and the like.

The processing unit 16 executes various functional applications and data processing, for example, implementing the methods mentioned in the foregoing embodiments, by running programs stored in the system memory 28.

In the description of the present disclosure, it is to be understood that, terms such as “first” and “second” are used herein for purposes of description and are not intended to indicate or imply relative importance or significance. Thus, the feature defined with “first” and “second” may comprise one or more this feature. In the description of the present disclosure, “a plurality of” means at least two, for example, two or three, unless specified otherwise.

In the description of the specification, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Although embodiments of present disclosure have been shown and described above, it should be understood that above embodiments are just explanatory, and cannot be construed to limit the present disclosure, for those skilled in the art, changes, modifications, alternatives, and variations can be made to the embodiments within the scope of the present disclosure.

What is claimed is:

1. An information processing method, comprising:
detecting whether input information on a current application interface comprises a named entity;
in response to detecting that the input information comprises the named entity, acquiring and displaying an entity content corresponding to the named entity on the current application interface; and
acquiring a transmitting instruction, and transmitting the entity content to a target user.

2. The method of claim 1, wherein before acquiring and displaying the entity content corresponding to the named entity on the current application interface, the method further comprises:
acquiring an entity type corresponding to the named entity; and
displaying an entity icon corresponding to the entity type on the current application interface;
and, wherein acquiring and displaying the entity content corresponding to the named entity on the current application interface comprises:
detecting whether a triggering operation is performed on the entity icon; and
in response to detecting that the triggering operation is performed on the entity icon, acquiring and displaying the entity content corresponding to the named entity on the current application interface.

3. The method of claim 1, wherein after acquiring and displaying the entity content corresponding to the named entity on the current application interface, the method further comprises:
detecting whether the transmitting instruction is acquired within a preset time period; and
in response to detecting that the transmitting instruction is not acquired, canceling displaying of the entity content.

4. The method of claim 2, wherein after acquiring and displaying the entity content corresponding to the named entity on the current application interface, the method further comprises:
detecting whether the transmitting instruction is acquired within a preset time period; and
in response to detecting that the transmitting instruction is not acquired, canceling displaying of the entity content.

5. The method of claim 1, further comprising:
detecting whether the input information on the current application interface comprises an emotion entity;
in response to detecting that the input information comprises the emotion entity, acquiring and displaying an emotion picture corresponding to the emotion entity on the current application interface; and
acquiring the transmitting instruction, and transmitting the emotion picture to the target user.

6. The method of claim 2, further comprising:
detecting whether the input information on the current application interface comprises an emotion entity;
in response to detecting that the input information comprises the emotion entity, acquiring and displaying an emotion picture corresponding to the emotion entity on the current application interface; and
acquiring the transmitting instruction, and transmitting the emotion picture to the target user.

7. The method of claim 3, further comprising:
detecting whether the input information on the current application interface comprises an emotion entity;
in response to detecting that the input information comprises the emotion entity, acquiring and displaying an emotion picture corresponding to the emotion entity on the current application interface; and
acquiring the transmitting instruction, and transmitting the emotion picture to the target user.

8. The method of claim 4, further comprising:
detecting whether the input information on the current application interface comprises an emotion entity;
in response to detecting that the input information comprises the emotion entity, acquiring and displaying an emotion picture corresponding to the emotion entity on the current application interface; and
acquiring the transmitting instruction, and transmitting the emotion picture to the target user.

9. The method of claim 5, wherein before acquiring and displaying the emotion picture corresponding to the emotion entity on the current application interface, the method further comprises:
displaying a picture identifier on the current application interface;
and wherein acquiring and displaying the emotion picture corresponding to the emotion entity on the current application interface comprises:
detecting whether a triggering operation is performed on the picture identifier; and
in response to detecting that the triggering operation is performed on the picture identifier, acquiring and displaying the emotion picture corresponding to the emotion entity on the current application interface.

10. The method of claim 6, wherein before acquiring and displaying the emotion picture corresponding to the emotion entity on the current application interface, the method further comprises:
displaying a picture identifier on the current application interface;
and, wherein acquiring and displaying the emotion picture corresponding to the emotion entity on the current application interface comprises:
detecting whether a triggering operation is performed on the picture identifier; and
in response to detecting that the triggering operation is performed on the picture identifier, acquiring and displaying the emotion picture corresponding to the emotion entity on the current application interface.

11. The method of claim 5, wherein after acquiring and displaying the emotion picture corresponding to the emotion entity on the current application interface, the method further comprises:
detecting whether the transmitting instruction is acquired within a preset time period; and
in response to detecting that the transmitting instruction is not acquired, canceling displaying of the emotion picture.

12. The method of claim 9, wherein after acquiring and displaying the emotion picture corresponding to the emotion entity on the current application interface, the method further comprises:
detecting whether the transmitting instruction is acquired within a preset time period; and
in response to detecting that the transmitting instruction is not acquired, canceling displaying of the emotion picture.

13. A terminal device, comprising a processor and a memory;
wherein the processor is configured to execute a program corresponding to an executable program code by reading the executable program code stored in the memory to:
detect whether input information on a current application interface comprises a named entity;
in response to detecting that the input information comprises the named entity, acquire and display entity content corresponding to the named entity on the current application interface; and
acquire a transmitting instruction, and transmit the entity content to a target user.

14. The terminal device of claim 13, wherein the processor is further configured to:
acquire an entity type corresponding to the named entity; and display an entity icon corresponding to the entity type on the current application interface;
detect whether a triggering operation is performed by a user on the entity icon; and in response to detecting that the triggering operation is performed on the entity icon, acquire and display the entity content corresponding to the named entity on the current application interface.

15. The terminal device of claim 13, wherein the processor is further configured to:
detect whether the transmitting instruction is acquired within a preset time period; and
in response to detecting that the transmitting instruction is not acquired, cancel displaying of the entity content.

16. The terminal device of claim 13, wherein the processor is further configured to:
detect whether the input information on the current application interface comprises an emotion entity;
in response to detecting that the input information comprises the emotion entity, acquire and display an emotion picture corresponding to the emotion entity on the current application interface; and
acquire the transmitting instruction, and transmit the emotion picture to the target user.

17. The terminal device of claim 16, wherein the processor is further configured to:
display a picture identifier on the current application interface; and
detect whether a triggering operation is performed on the picture identifier; and in response to detecting that the triggering operation is performed on the picture identifier, acquire and display the emotion picture corresponding to the emotion entity on the current application interface.

18. The terminal device of claim 16, wherein the processor is further configured to:
detect whether the transmitting instruction is acquired within a preset time period; and
in response to detecting that the transmitting instruction is not acquired, cancel displaying of the emotion picture.

19. A non-transitory computer-readable storage medium, having a computer program stored there, wherein when the computer program is executed by the processor, an information processing method is executed, the method comprising:
detecting whether input information on a current application interface comprises a named entity;
in response to detecting that the input information comprises the named entity, acquiring and displaying an entity content corresponding to the named entity on the current application interface; and
acquiring a transmitting instruction, and transmitting the entity content to a target user.

20. The non-transitory computer-readable storage medium of claim 19, wherein the method further comprises:
detecting whether the input information on the current application interface comprises an emotion entity;
in response to detecting that the input information comprises the emotion entity, acquiring and displaying an emotion picture corresponding to the emotion entity on the current application interface; and
acquiring the transmitting instruction, and transmitting the emotion picture to the target user.
